(19) United States
(12) Patent Application Publication
(10) Pub. No.: US 2024/0017855 A1
(43) Pub. Date: Jan. 18, 2024

(54) PROPELLER GUARD

(71) Applicant: NIPPON TELEGRAPH AND TELEPHONE CORPORATION, Tokyo (JP)

(72) Inventors: Daisuke UCHIBORI, Tokyo (JP); Yujin HAMANO, Tokyo (JP); Kazuaki WATANABE, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/029,095

(22) PCT Filed: Sep. 30, 2020
(86) PCT No.: PCT/JP2020/037376

§ 371 Date: Mar. 29, 2023

(51) Int. Cl. B64U 30/299

(52) U.S. Cl. CPC B64U 30/299; B64U 2101/26

(57) ABSTRACT

A propeller guard 10 includes a frame 16 provided along a rotating surface of a propeller 30 and surrounding a rotating end 30b of the propeller 30, in which the frame 16 includes a plurality of protrusions 16b protruding outward in plan view.

### DESCRIPTION

### Technical Field

The present disclosure relates to a propeller guard that protects a propeller of a flight vehicle.

### Background Art

In recent years, a flight vehicle (for example, a drone, a multicopter, or the like) that flies by rotation of a plurality of propellers may be used for inspection of an infrastructure structure.

In Non Patent Literature 1, a method is disclosed of using a flight vehicle for inspection of pipeline facilities buried in the ground. When the flight vehicle flies in such a space surrounded by a wall surface, if the airframe collides with an object such as the wall surface, the propeller may be damaged and the airframe may crash. Thus, a propeller guard that protects the propeller may be attached to the airframe.

In Non Patent Literature 2, a propeller guard is devised for protecting a propeller when a flight vehicle collides with an object and preventing the flight vehicle from losing a flight balance and becoming uncontrollable even when the flight vehicle collides with the object.

### Citation List

### Non Patent Literature

Non Patent Literature 1: Yoshihiko Yato et al., “Development of drone capable of coping with closed space such as sewer pipeline”, 29th Trenchless Technology Conference, 2.1, 2018

Non Patent Literature 2: Noriyuki Kanehira et al., “Development of a Drone Bridge Inspection System”, Kawada Technical Report, vol. 38, 2019

### SUMMARY OF INVENTION

### Technical Problem

However, when the flight vehicle moves in the vertical direction in a space surrounded by a wall surface, in the propeller guard devised in Non Patent Literature 2,there is a possibility that the guard frame comes into contact with a protrusion and the flight vehicle loses its balance and falls.

FIG. 6 is a cross-sectional view of a manhole 50. As illustrated in FIG. 6, in the manhole 50, when a manhole lid installed on the ground is opened and closed, a columnar or quadrangular prism structure 51 (for example, reinforced concrete pipe) extends in the vertical direction in the ground, and a step 52 for a worker to go down to the underground or to go up to the ground is installed in the middle.

FIG. 7 is a diagram illustrating a problem in a case where a flight vehicle 100 with a propeller guard moves in a space surrounded by a wall surface, such as the manhole 50. As illustrated in FIG. 7, when the flight vehicle 100 with the propeller guard is caused to ascend in the structure 51, the propeller guard may be caught by the wall surface or the like of the structure 51. In this case, the flight vehicle 100 sucks air from above the propeller and discharges the air downward to float the airframe in the air, and thus, there is a possibility that the flight vehicle 100 rotates in an R direction with a contact point P1 between the propeller guard and the wall surface of the structure 51 as a fulcrum, and the flight vehicle 100 sticks to the wall surface of structure 51 and falls.

An object of the present disclosure made in view of such circumstances is to provide a propeller guard capable of suppressing occurrence of rotation of a flight vehicle due to contact with an object.

### Solution to Problem

A propeller guard according to an embodiment is a propeller guard attached to a flight vehicle including a propeller and protecting the propeller, the propeller guard including a frame provided along a rotating surface of the propeller and surrounding a rotating end of the propeller, in which the frame includes a plurality of protrusions protruding outward in plan view.

### Advantageous Effects of Invention

According to the present disclosure, it is possible to provide a propeller guard capable of suppressing occurrence of rotation of a flight vehicle due to contact with an object.

### BRIEF DESCRIPTION OF DRAWINGS

FIG. 1 is an example of a side view of a flight vehicle including a propeller guard according to an embodiment.

FIG. 2 is an example of a top view of a frame illustrated in FIG. 1.

FIG. 3A is another example of a top view of the frame illustrated in FIG. 2.

FIG. 3B is still another example of the top view of the frame illustrated in FIG. 2.

FIG. 4A is a view illustrating an example of a shape of a protrusion illustrated in FIGS. 2, 3A, and 3B.

FIG. 4B is a diagram illustrating another example of the shape of the protrusion illustrated in FIGS. 2, 3A, and 3B.

FIG. 4C is a diagram illustrating still another example of the shape of the protrusion illustrated in FIGS. 2, 3A, and 3B.

FIG. 5A is a diagram illustrating an example of a state in which a flight vehicle including a propeller guard according to the present embodiment and a flight vehicle including a conventional propeller guard fly in a structure.

FIG. 5B is a diagram illustrating another example of the state in which the flight vehicle including the propeller guard according to the present embodiment and the flight vehicle including the conventional propeller guard fly in the structure.

FIG. 6 is an example of a cross-sectional view of a manhole.

FIG. 7 is a diagram illustrating a problem of a flight vehicle including a conventional propeller guard.

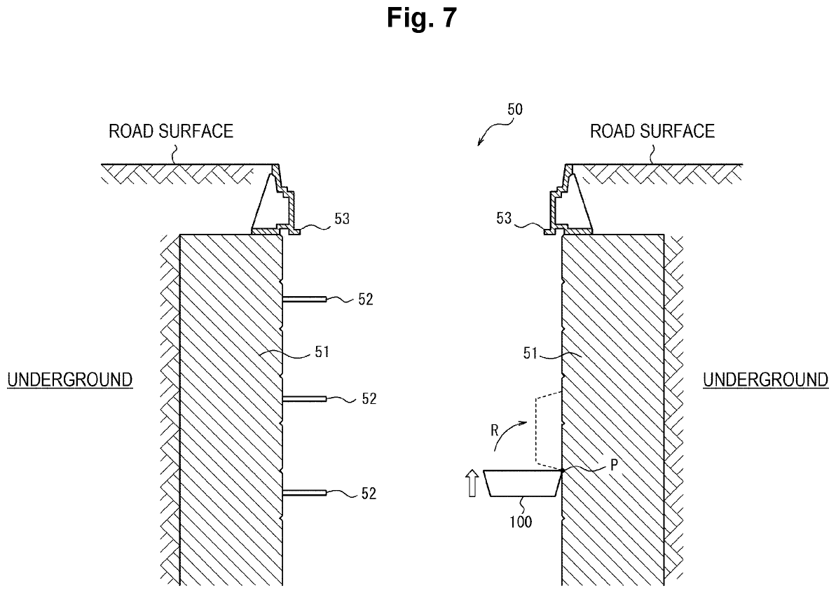

### Description of Embodiments

Hereinafter, an embodiment will be described in detail with reference to the drawings. Note that the drawings are only schematically illustrated to the extent that the present invention can be sufficiently understood. Thus, the present invention is not limited only to the illustrated examples. In addition, for convenience of illustration, scales in the drawings may be different from actual scales, or may not match between the drawings.

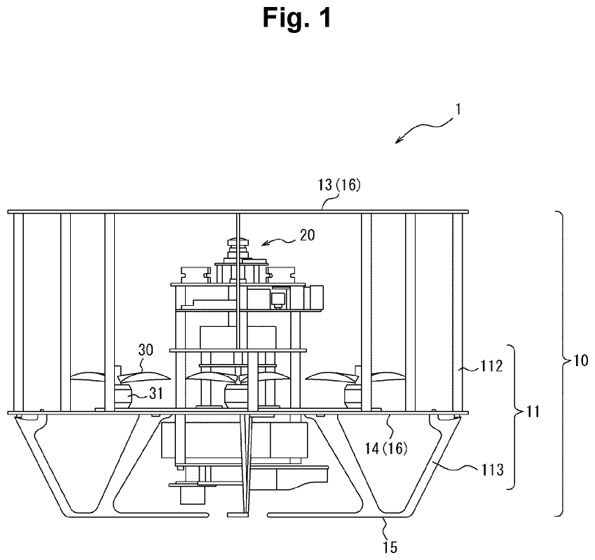

FIG. 1 is a diagram illustrating an example of a configuration of a flight vehicle including a propeller guard (Hereinafter, it is simply referred to as a “flight vehicle”.) 1 according to an embodiment of the present disclosure, and is a side view of the flight vehicle 1. The flight vehicle 1 illustrated in FIG. 1 includes a propeller guard 10, a flight vehicle body 20, and one or more propellers 30. The flight vehicle 1 flies by the one or more propellers each having a vertical rotation axis.

The propeller guard 10 is configured to surround the propellers 30 in a state of being attached to the flight vehicle 1, and protects the propellers 30. The propeller guard 10 may be configured to surround not only the propellers 30 but also a whole of the flight vehicle body as illustrated in FIG. 1. The propeller guard 10 may be configured to surround a part of the flight vehicle body

In the example illustrated in FIG. 1, the propeller guard 10 includes a coupling frame 11, an upper frame 13, a lower frame 14, and a base frame 15. The number of coupling frames 11 is not limited to one, and can be arbitrarily determined. Note that an intermediate frame parallel to the upper frame 13 and the lower frame 14 may be further provided between the upper frame 13 and the lower frame 14. Whether or not to provide the intermediate frame and the number of the coupling frames 11 and the intermediate frames affect strength of the propeller guard 10. Thus, for example, in a case where it is assumed that the flight vehicle 1 is moved at a high speed, one or a plurality of the intermediate frames may be provided and the number of the coupling frames 11 may be increased to increase the strength of the propeller guard 10.

The upper frame 13 is a frame provided on the uppermost surface of the propeller guard 10. The upper frame 13 is provided along a rotating surface (In FIG. 1, a surface extending in the left-right direction of the figure) of the propeller 30.

The lower frame 14 is a frame provided substantially parallel to the upper frame 13. That is, the lower frame 14 is provided along the rotating surface of the propeller 30. A motor 31 for the propeller 30 is mounted on the lower frame 14.

As described above, the propeller guard 10 according to the present embodiment includes the upper frame 13 and the lower frame 14 as frames 16 provided along the rotating surface of the propeller 30. Although FIG. 1 illustrates an example in which the propeller guard 10 includes the upper frame 13 and the lower frame 14 as the frames 16, it is not limited thereto. The propeller guard 10 may have a configuration in which, for example, the upper frame 13, the lower frame 14, and an intermediate frame provided between the upper frame 13 and the lower frame 14 are coupled together by the coupling frame 11.

The base frame 15 is installed below the lower frame 14 (at the lowermost surface of the propeller guard 10) substantially parallel to the upper frame 13, and is a frame to be in contact with an object such as the ground at the time of landing of the flight vehicle 1. The base frame 15 provides stability at the time of landing of the flight vehicle 1 and protects the bottom of the flight vehicle 1. Center points of the upper frame 13, the lower frame 14, and the base frame 15 are desirably located on a center axis of the flight vehicle body 20 to balance the flight vehicle during flight.

The coupling frame 11 is a frame that couples the upper frame 13, the lower frame 14, and the base frame 15 together. The coupling frame 11 includes a first coupling portion 112 that couples the upper frame 13 and the lower frame 14 together, and a second coupling portion 113 that couples the lower frame 14 and the base frame 15 together.

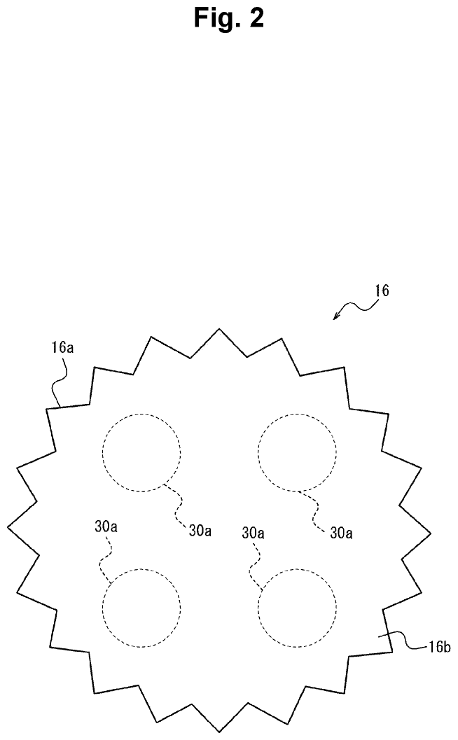

FIG. 2 is a diagram illustrating an example of a shape of the frame 16, and is a top view of the frame 16. The frame 16 is configured by coupling a plurality of rod- shaped members, for example, but only an outer edge 16a of the frame 16 is illustrated in FIG. 2. In addition, in

FIG. 2, a locus 30a in a case where a rotating end of the propeller 30 is projected on the frame 16 is indicated by a broken line.

As illustrated in FIG. 2, the frame 16 has a shape in which the locus 30a of the rotating end of the propeller is included in the outer edge 16a of the frame 16 in a case where the locus 30a of the rotating end of the propeller 30 is projected on the frame 16. In the present description, the “outer edge” of the frame 16 means a line along an annular shape in a case where the frame 16 is annular, and means a line connecting outer end points together in a case where the frame 16 is not annular.

In addition, the frame 16 includes a plurality of protrusions 16b protruding outward in plan view as viewed in a direction perpendicular to the frame 16 (as viewed in a direction perpendicular to the figure). FIG. 2 illustrates an example in which 20 protrusions 16b are provided along the circumferential direction of the frame 16.

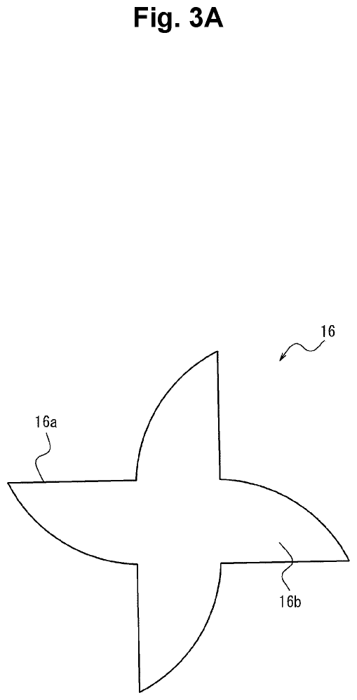

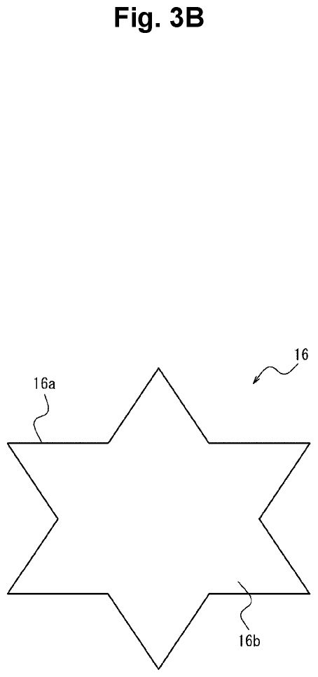

FIG. 2 illustrates an example in which the frame 16 includes 20 protrusions 16b along the circumferential direction, but it is not limited thereto. As illustrated in FIG. 3A, the frame 16 may include four protrusions 16b. In addition, as illustrated in FIG. 3B, the frame 16 may include six protrusions 16b. The number of protrusions 16b included in the frame 16 is arbitrary. However, to maintain balance at the time of horizontal movement, as illustrated in FIGS. 2, 3A, and 3B, the shape of the outer edge 16a of the frame 16 is desirably point-symmetric. Note that, in the present description, the “horizontal direction” means a direction substantially orthogonal to the vertical direction.

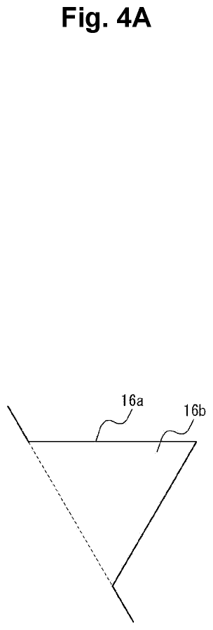

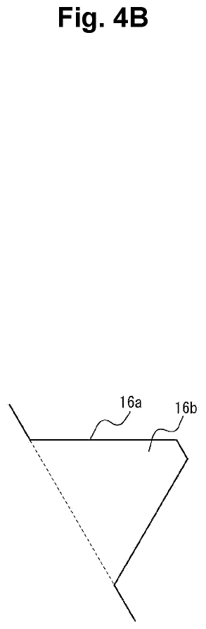

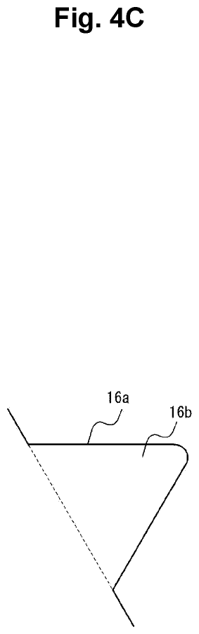

Although the protrusion 16b has any shape, it is desirable that the protrusion has an outwardly tapered shape for example, as illustrated in FIG. 4A. In addition, the shape of the protrusion 16b may be a trapezoidal shape in which the width decreases toward the outside as illustrated in FIG. 4B, or may be an elliptical shape in which its end is chamfered as illustrated in FIG. 4C.

In the propeller guard 10, at least one of the upper frame 13 or the lower frame 14 is configured by the frame 16 including the protrusion 16b described above. Which one of the upper frame 13 and the lower frame 14 is configured by the frame 16 may be determined by a shape of the propeller guard 10, a place where the flight vehicle 1 is scheduled to fly, and the like.

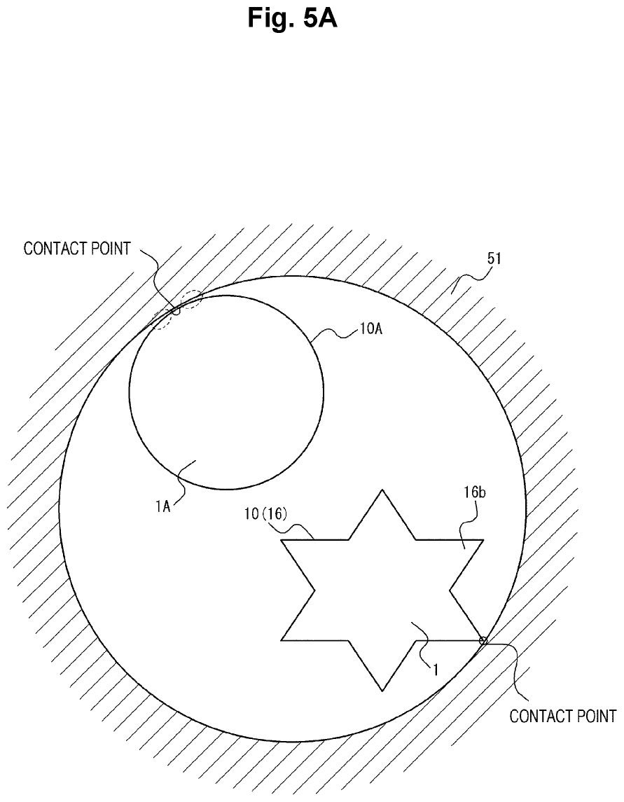

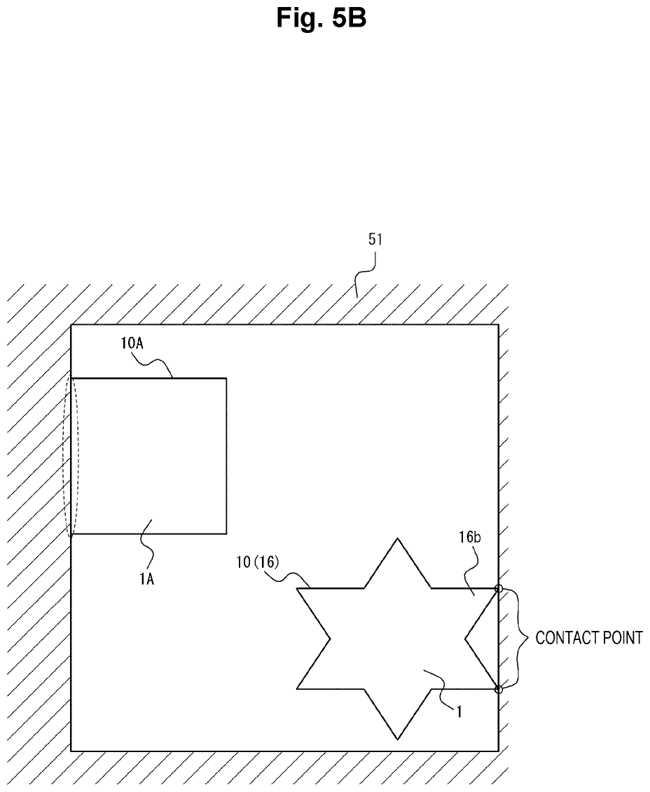

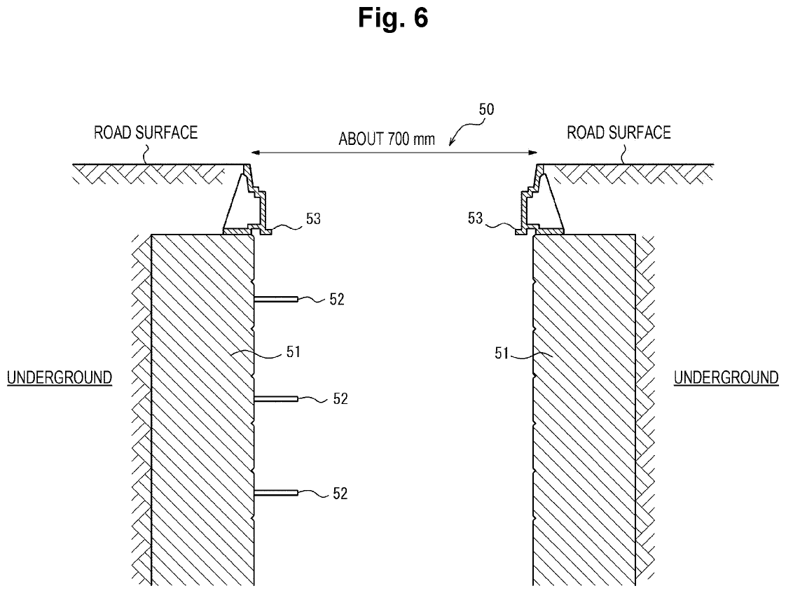

FIGS. 5A and 5B are diagrams of states in which the flight vehicle 1 including the propeller guard 10 according to the present embodiment and a flight vehicle 1A including a conventional propeller guard 10A without the protrusion 16b fly in the structure 51 surrounded by the wall surface like the manhole 50 illustrated in FIG. 6, as viewed from the vertical direction. FIGS. 5A and 5B illustrate examples in which the shape of the frame 16 included in the propeller guard 10 is a star shape as illustrated in FIG. 3B. In addition, FIG. 5A illustrates an example in which a space in which the flight vehicles 1 and 1A fly is a space surrounded by a circular wall surface, and a shape of the propeller guard 10A included in the flight vehicle 1A in plan view is circular. In addition, FIG. 5B illustrates an example in which the space in which the flight vehicles 1 and 1A fly is a space surrounded by a planar wall surface, and the propeller guard 10A included in the flight vehicle 1A has a rectangular shape in plan view. FIGS. 5A and 5B illustrate only outer edges of the frames of the propeller guards 10 and 10A of the flight vehicles 1 and 1A, and do not illustrate the flight vehicle body 20, the propellers 30, and the like.

Usually, the wall surface of the structure 51 includes concrete or the like. For that reason, a surface of the wall surface of the structure 51 is not smooth, and unevenness due to fine aggregate or the like exists.

As illustrated in FIG. 5A, in a case where the wall surface of the structure 51 is circular and a shape of the propeller guard 10A of the flight vehicle 1A is a circular shape, when the propeller guard 10A and the wall surface come into contact with each other, a distance between the propeller guard 10A and the wall surface is short even in the vicinity of a contact point (in FIG. 5A, a portion indicated by a dotted circular mark), and the propeller guard 10A may be caught by the wall surface. When the propeller guard 10A is caught by the wall surface of the structure 51, the flight vehicle 1A rotates with a point where catching occurs, as a fulcrum, and the flight vehicle 1A may stick to the wall surface of the structure 51 and fall.

In addition, as illustrated in FIG. 5B, in a case where the wall surface of the structure 51 is a flat surface and the shape of the propeller guard 10A of the flight vehicle 1A is a rectangular shape, a portion where the propeller guard 10A and the wall surface are close to each other (in FIG. 5B, a portion indicated by a dotted circular mark) is large, and the propeller guard 10A is easily caught by the wall surface. As a result, there is a possibility that the flight vehicle 1A rotates with the point where the catching occurs, as a fulcrum, and the flight vehicle 1A sticks to the wall surface of the structure 51 and falls.

On the other hand, in the propeller guard 10 according to the present embodiment, since a contact portion between the frame 16 and the wall surface of the structure 51 is limited to the end of the protrusion 16b, the propeller guard 10 is less likely to be caught by the wall surface of the structure 51. For that reason, it is possible to suppress occurrence of rotation of the flight vehicle 1 due to contact (catching) with the structure 51.

The above-described embodiment has been described as a typical example, and it is apparent to those skilled in the art that many modifications and substitutions can be made within the spirit and scope of the present disclosure. Thus, it should not be understood that the present invention is limited by the above-described embodiment, and various modifications or changes can be made without departing from the scope of the claims.

### Reference Signs List

1, 1A, 100 flight vehicle
10 propeller guard
11 coupling frame
13 upper frame
14 lower frame
15 base frame
16 frame
16a outer edge of frame
16b protrusion
20 flight vehicle body
30 propeller
112 first coupling portion
113 second coupling portion
50 manhole
51 structure
52 step
53 manhole lid receiving frame

1. A propeller guard attached to a flight vehicle including a propeller and protecting the propeller, the propeller guard comprising
a frame provided along a rotating surface of the propeller and surrounding a rotating end of the propeller, wherein
the frame includes a plurality of protrusions protruding outward in plan view.

2. The propeller guard according to claim 1, wherein the plurality of protrusions has outwardly tapered shapes.

3. The propeller guard according to claim 1, wherein the frame has a point symmetrical shape in plan view.

4. The propeller guard according to claim 1, wherein the plurality of protrusions have elliptical shape with its end chamfered.

5. The propeller guard according to claim 2, wherein the propeller guard prevents rotation of the flight vehicle in case of the flight vehicle being in contact with an object.

6. The propeller guard according to claim 2, wherein the propeller guard prevents the propeller from being caught on a protruding object from a wall surface while the flight vehicle moves in a space surrounded by the wall surface.

7. The propeller guard according to claim 6, wherein the space includes an underground section.

8. A flight vehicle, comprising:
a propeller;
a propeller guard, wherein the propeller guard comprises:
a frame provided along a rotating surface of the propeller and surrounding a rotating end of the propeller, wherein
the frame includes a plurality of protrusions protruding outward in plan view.

9. The flight vehicle according to claim 8, wherein the plurality of protrusions has outwardly tapered shapes.

10. The flight vehicle according to claim 8, wherein the frame has a point symmetrical shape in plan view.

11. The flight vehicle according to claim 8, wherein the plurality of protrusions has elliptical shape with its end chamfered.

12. The flight vehicle according to claim 9, wherein the propeller guard prevents rotation of the flight vehicle in case of the flight vehicle being in contact with an object.

13. The flight vehicle according to claim 9, wherein the propeller guard prevents the propeller from being caught on a protruding object from a wall surface while the flight vehicle moves in a space surrounded by the wall surface.

14. The flight vehicle according to claim 13, wherein the space includes an underground section.

15. A guard mechanism for a propeller attached to a flight vehicle, comprising:
the propeller;
a propeller guard, wherein the propeller guard comprises:
a frame provided along a rotating surface of the propeller and surrounding a rotating end of the propeller, wherein
the frame includes a plurality of protrusions protruding outward in plan view.

16. The guard mechanism according to claim 15, wherein the plurality of protrusions have outwardly tapered shapes.

17. The guard mechanism according to claim 15, wherein the frame has a point symmetrical shape in plan view.

18. The guard mechanism according to claim 15, wherein the plurality of protrusions have elliptical shape with its end chamfered.

19. The guard mechanism according to claim 16, wherein the propeller guard prevents rotation of the flight vehicle in case of the flight vehicle being in contact with an object.

20. The guard mechanism according to claim 16, wherein the propeller guard prevents the propeller from being caught on a protruding object from a wall surface while the flight vehicle moves in a space surrounded by the wall surface.
